(19) United States
(12) Patent Application Publication
(10) Pub. No.: US 2012/0151491 A1
(43) Pub. Date: Jun. 14, 2012

(54) Redistributing incomplete segments for processing tasks in distributed computing

(75) Inventors: Nikolaos Georgis, San Diego, CA (US); Adrian Crisan, San Diego, CA (US); Milton M. Frazier, San Marcos, CA (US)

(73) Assignee: Sony Corporation, Tokyo (JP)

(21) Appl. No.: 12/926,784

(22) Filed: Dec. 9, 2010

(51) Int. Cl. G06F 9/46

(52) U.S. Cl. 718/104

(57) ABSTRACT

A method or system for redistributing incomplete segments for processing tasks by generating a model based on resources of a plurality of separate electronic devices; simulating an assessment task to determine a computation time for the assessment task according to the model; updating the model to optimize the computation time based on a dynamic availability of the resources and a processing requirement of a live task; distributing task segments for processing the live task based on the updated model; and dynamically redistributing incomplete segments for processing the live task by further updating the model based on the dynamic availability of the resources.

### BACKGROUND OF THE INVENTION

1. Field of the Invention

The application relates generally to a method or system for redistributing incomplete segments for processing a live tasks based on a dynamic availability of the resources within a system.

2. Description of the Related Art

Although group computing and collective rendering systems are currently in practice, their current employment is limited in a number of ways.

First, for example, the World Community Grid (WCG) gives personal computer owners the ability to donate their spare or idle personal computer into a contributory processing scheme, known as distributed computing, where their personal computer becomes part of an elaborate super-computer. Thus, the super-computer is not a central machine located in the rooms of a development or research lab, rather it is the combination of thousands upon thousands of computers that in the aggregate work as one super-computer processing a single task.

Unfortunately, however, the WCG only permits task initiation by the scientists who need to analyze data and run simulations. The user is simply a contributor and does not gain a benefit from connecting to an aggregate processing system. An appropriate method requesting computation of a task, storing data, correcting data, or tracking donations by a user is absent from this system.

Further, the WCG requires users to actively sign-up to contribute, while not offering users a mechanism for forming and creating their own groups.

Furthermore, because users are unable to form their own groups the WCG lacks any ability for a user to utilize contact folders, trusted online communities, social sites, gaming communities, blog memberships, etc. in forming their own groups within the system.

### SUMMARY OF THE INVENTION

The present invention relates to a method or system for redistributing incomplete segments for processing tasks by generating a model based on resources of a plurality of separate electronic devices; simulating an assessment task to determine a computation time for the assessment task according to the model; updating the model to optimize the computation time based on a dynamic availability of the resources and a processing requirement of a live task; distributing task segments for processing the live task based on the updated model; and dynamically redistributing incomplete segments for processing the live task by further updating the model based on the dynamic availability of the resources.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a flow chart illustrating a process for modeling, optimizing, distributing and redistributing.

FIG. 2 is a flow chart illustrating a process for detecting and modeling resources.

FIG. 3 is a flow chart illustrating a process for calculation of device component availability.

FIG. 4 is a flow chart illustrating a process for system optimization.

FIG. 5 is a flow chart illustrating a process for task segmentation.

FIG. 6 is a flow chart illustrating a process for redistributing incomplete segments.

FIGS. 7a-7c are graphs illustrating CPU status over time.

FIG. 8 is a display diagram indicating a device's resource use.

FIG. 9 is a display diagram indicating the time to render a frame.

FIG. 10 is a block diagram illustrating a device for calculating and distributing resources.

FIG. 11 is a schematic diagram of a system for calculating and distributing resources.

FIG. 12 is a schematic diagram of a self-discoverable electronic device for calculating and distributing resources.

### DETAILED DESCRIPTION OF THE INVENTION

In the following description, for purposes of explanation, numerous details are set forth, such as flowcharts and system configurations, to provide an understanding of one or more embodiments of the present invention. However, it is and will be apparent to one skilled in the art that these specific details are not required to practice the present invention.

The present invention relates to a method for generating a model based on resources of a plurality of separate electronic devices; simulating an assessment task to determine a computation time for the assessment task according to the model; updating the model to optimize the computation time based on a dynamic availability of the resources and a processing requirement of a live task; distributing task segments for processing the live task based on the updated model; and dynamically redistributing incomplete segments for processing the live task by further updating the model based on the dynamic availability of the resources.

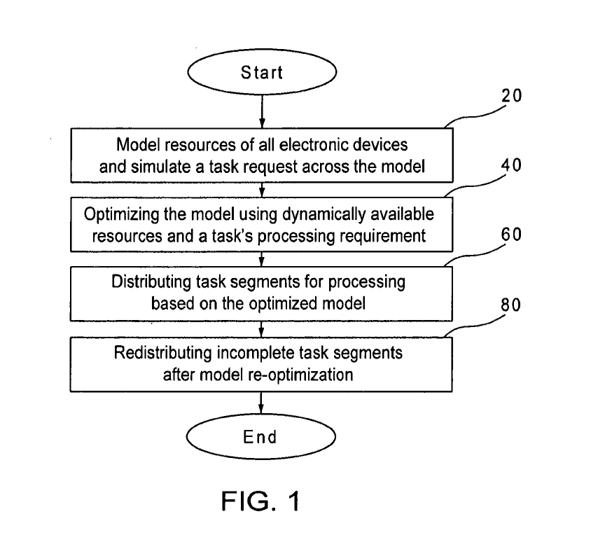

FIG. 1 is a flow chart illustrating a process for modeling, optimizing, distributing and redistributing. In FIG. 1, resources are modeled 20 and an assessment task is simulated 20 to calculate and test the processing power of a system. Then, updating 40 or optimization of the model using the dynamic availability of the resources is performed. A live task's or assessment task's processing requirement may be used to update 40 the model. Next, distribution 60 of task segments for processing is performed based on the optimized model. After the model is updated, redistributing 80 of incomplete segments is performed.

The initial modeling 20 is a first calculation of resources and provides the foundation for a later updating 40 or dynamic modeling and optimization.

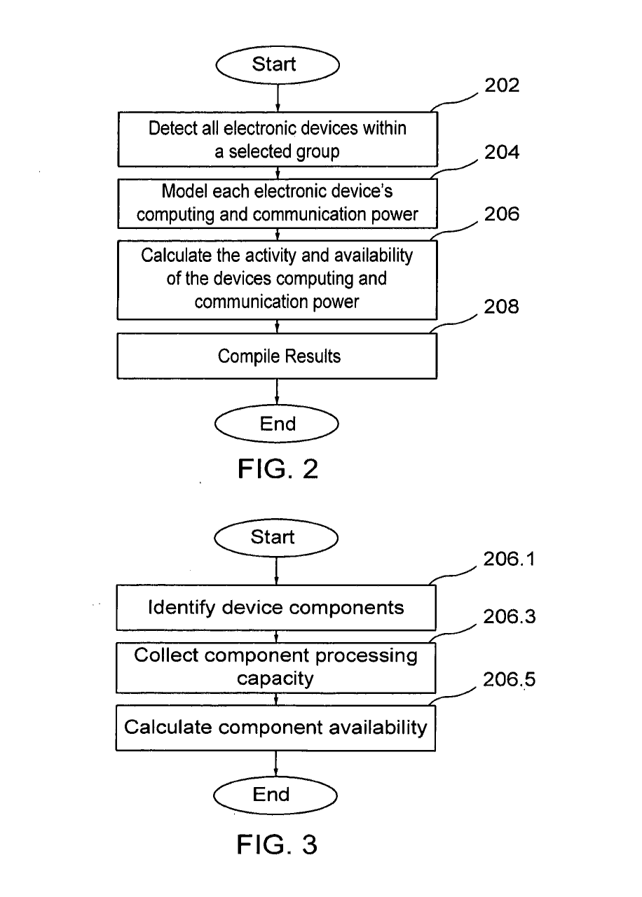

FIG. 2 is a flow chart illustrating a process for detecting and modeling resources. To calculate the resources within a group, as indicated in FIG. 2, a system detects 202 the electronic devices within a selected group. Group selection may be based on any number of selection algorithms, contact lists, or social networking groups whether combined or taken individually. Detection 202 may be a handshaking where one device verifies that another is connected within the selected group. For example, detecting 202 an electronic device may be effected by a system seeking selected group members through an echo request, such as ping, or a MAC address look-up. Detection 202 is not limited to these mechanisms and may be carried out by any number or combination of detection mechanisms.

After detection 202 the components and connections of the detected electronic devices are modeled 204. Modeling 204 preferably “traces” the capabilities of the detected electronic devices, regardless of the device type.

For example, a laptop personal computer (laptop) is detected 202 by first receiving a ping to verify a connection and, once the connection is verified, a modeling 204 or diagnostics test reveals the laptop's internal components of a read only memory (ROM), random access memory (RAM), graphics processor, central processing unit (CPU), network interface card, etc.

An electronic device is not limited to a laptop. Other examples include a mobile phone, a hand-held device, a personal computer, a digital clock, a digital watch, a global positioning system device, a scanner, a printer, a home theatre system, a gaming machine, an electronic desk phone, a vehicle stereo, a vehicle's management computer, an handheld music player, a dishwasher, a microwave, a security system, a camera, a camcorder, or any other electronic device that has a processor and network interface. Thus, an electronic device may be a simple device, a complex device, such as a high-tech supercomputer with multiple processors and connections, or various other devices between those extremes. The network interface may be any communication technology that allows data transfer, such as an IP WAN/LAN network, WiFi network, Bluetooth, 3G wireless, 4G wireless, an IR interface, satellite, or microwaves.

Next, a process calculates 206 the activity and availability of the devices' computing and communication power. In other words, each electronic device may not be ready to contribute its full resources to the system. Each electronic device may be running subroutines, browsing the web, playing a movie, or processing other tasks that require resources. Therefore, the electronic device may only have a portion or percentage of availability for its components and connections.

For instance, a laptop may only be running a virus scan wherein 10% of the CPU's processing power is being used. Thus, the network interface and graphics card are fully available to donate. Further, a laptop may also be streaming a movie from an online source. Thus, the graphics card may not available and the processor may be limited to a 90% donation.

Further, the results of calculating 206 the activity and availability of the devices computing and communication power are compiled 208. Compiling 208 presents a data set for updating or optimizing a model for task distribution and repeating a simulation over the updated model. For example, simulating an assessment task may assume maximization of a total processing power of the modeled resources of a plurality of separate electronic devices, such that a time estimate is rendered for the case where all resources are in use. This simulation on an updated model may generate a result set that may indicate that the processing time for a live task, which does not maximize a total processing power, may be less than the simulation estimate. In addition, simulation may be performed locally (that is statistically calculated on the distributing electronic device) or across the system using a test task and the modeled data.

FIG. 3 is a flow chart illustrating a process for calculation of device component availability. The process includes identifying 206.1 the specific components within a laptop. When identifying components the system may tag or label these components for a specific task type. Further, a system may use the identifying 206.1 portion of the process to compare components past performance and give a rating or ranking based on that performance. For instance, a graphics processor may be more suited for picture annotation while a CPU may be designated for algorithms. These identifying constraints may be based on the level of control the system should have in distributing. Furthermore, the process includes collecting 206.3 the total processing capacity for each component and calculating 206.5 the idle percentage of the component by utilizing a component's total processing capacity. Similarly to identifying 206.1, collecting 206.3 and calculating 206.5 may contribute to component labeling

With the model built and the simulation complete a system may use a result set for updated 40 the model using the dynamic availability of the resources and a task's processing requirement. A “second tracing” is conducted, where the resources of an electronic device, i.e., a set of processors, a set of memory modules, and communication types, are inspected for activity. The second tracing reveals the dynamic availability, which is the current status of a component or device. The dynamic availability of a resource often will change over time. The processors, memory modules, and communication types may receive different tasks from different sources. It is important to account for these changes to render the optimal processing time.

The system may constantly monitor and optimize 40 the model based on activity within the system while waiting for a task request to render an optimal processing time for any given task. Further, the system may, after an initial model is complete, utilize the initial model and activity within the system for statistical optimization. Optimizing and updating may be used interchangeably when refereeing to adjusting the model in real time.

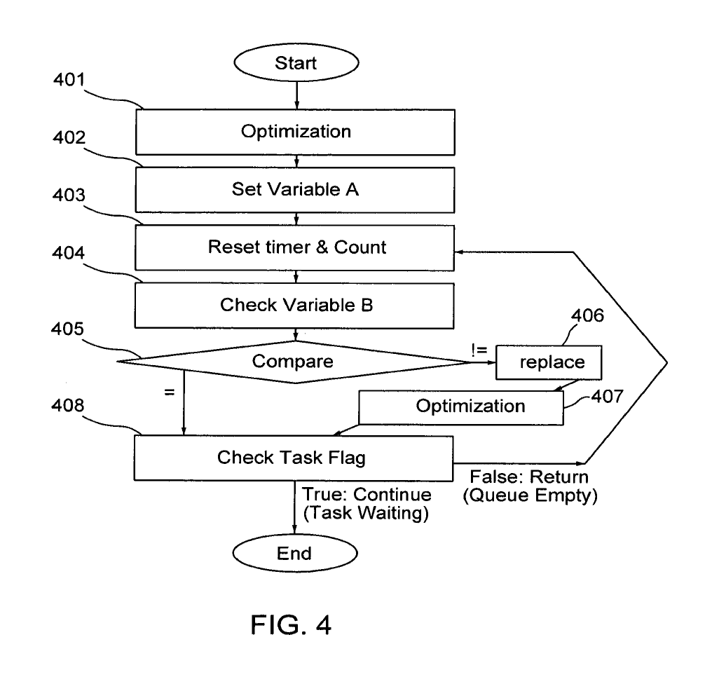

FIG. 4 is a flow chart illustrating a process for system optimization. In FIG. 4, a system may monitor the system and perform an initial optimization 401. When optimizing 401, the system utilizes the model to calculate the optimal distribution for the fastest task processing, which should be sufficiently below a task's processing requirement. A task's processing requirement may be based on a task that is in the system's waiting to be processed queue, on a task history, or on the results generated from the simulation.

After optimization 401, a first variable, which may be assigned to a specific component within an electronic device or the device itself, may be set 402 to a value equal to the idle time or to a value that indicates the dynamic availability of that component or device. Variable setting 402 may be repeated for each component per device in a system, for each device in a system, or for any desired level of optimization granularity and is not limited to a single component. Next, a timer is set and started 403. The timer or counter regulates how often the system checks, whether individually or collectively, the components, devices, or system. When the timer finishes, a component's or device's current idle time or dynamic availability is checked 404 and set to a second variable.

The first and second variables may then be compared 405. When the first and second variables are equal the system checks 408 a task flag. If the task flag is false, which means there are no tasks waiting to be distributed in the system, then the system resets the timer and counts again. Thus, the system may wait for a task while constantly checking the dynamic availability of the components and devices within the system. Similarly, if a task is in a queue the system may wait for an appropriate amount of resources before distributing. However, if the task flag is true then the system may end its dynamic optimization, and distribute task segments based on the current optimized model 60.

In addition, the system is not limited to optimization before distribution and after modeling, and other embodiments may include an optimization simultaneous with distributing, modeling, or re-optimization.

When the first and second variables are not equal the second variable's value may replace 406 the first variable's value and the system may proceed to a second optimization 407. After optimization 407, the task flag is checked 408 and, as partially explained above, the system may continue monitoring, process a task, or end this sub-routine.

Optimization may dynamically and constantly cycle so the system and the task processing model are always active and updated, and, as such, when a task request is received the system may proactively know whether the task segments can be immediately distributed. In addition, the frequency of optimization may also be toggled or adjusted, for instance, the timer may be set to a low number thereby increasing the number of variable checks and model optimizations. Also, optimization may be any number of statistical techniques for finding the shortest processing time of a task, such as regression or standard deviation, and these techniques may be used interchangeably, collectively, in isolation, or in any similar manner.

Although in FIG. 1 optimization 40 (or updating a model) is illustrated before distributing 60, a system may optimize at any time. Further, it may be advantageous if the model were re-optimized after the first distribution of task segments, as the component availability would change once the component receives a task segment. Furthermore, optimization 40 may also generate a task segment predictability variable or timing variable. Since a system constantly optimizes a shared computing platform the system can predict an estimated time or a completion delay for a task segment's processing.

For example, a system may detect two laptops A and B that are equal electronic devices with equal system connections and the system may update a model based on this detection for equal distribution. Further, if a user begins an activity, such as web browsing, on laptop A, then the available resources for laptop A will decrease. When this decrease is detected (i.e. comparing 405 the past variable with current variable) the system may optimize 407 again.

In another optimizing example, when laptop A, which contains a state-of-the-art processor and connects to the system via a 56 k Modem, and laptop B, which contains a mid-level processor that is relatively slower than the state-of-the-art processor and connects to the system via a 1 GIG NIC, are detected by the system, the system may recognize the bottlenecks per device and statistically optimize the model for distributing tasks. Thus, although the laptop A processor is faster than laptop B the network connections for both Laptops will contribute proportionally to the optimization.

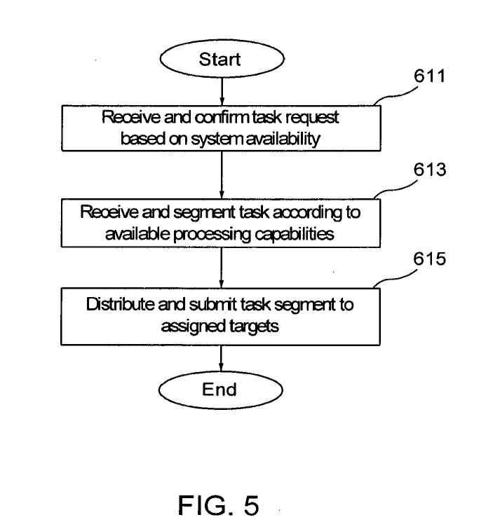

FIG. 5 is a flow chart illustrating a process for task segmentation. Regarding FIG. 5, the system receives a task request and confirms 611 the task request based on resource availability. The system may verify a threshold percentage of available resources, such that if the system does not have available resources then the system may deny the request to process a task. Alternatively, the system may confirm the receipt of a task request but deny processing until further resources are available, or the system may add the task request to a task request queue. The queue may be a first in first out queue or other alternatives, such as a last in first out stack. Also, the validation of resources may be based on the model or optimized model.

After receipt and confirmation 611 of a task request, a task is received and segmented 613 into task segments. During segmentation, the system establishes target connections and device resources for each segment based on an optimized model. When the model proactively optimized the system may move quickly distribute or submit 615 the task segments to their assign targets. Further, the system may and estimate a completion time based on the model (or optimized model) and assigned targets.

A system may wait to compile the returned processed task segments. The system may use a timer to count for the length of time equal to the estimated processing time for a task segment or may check a task segment receipt flag. If the task segment receipt flag is true then the task segment has been received and the system may proceed to compiling. If the task segment receipt flag is false then the task segment has not been received. The system may wait longer or exit the subroutine.

Thus, in the aggregate, a system may wait for a set of process task segments 1, check the relative task segment receipt flag RFI, and after either all the processed task segments were received or exit functions performed compile the sum Σ of processed task segments i where the segment receipt flag is true (RFi=1).

Regardless, it may be necessary to receive and compile each task segment to completely process a task and when the system has missing or incomplete segment the system may redistribute 80 the incomplete task segments after a model is further updated. It may be preferred that the system dynamically redistributes incomplete segments, such that as the system identifies an incomplete segment it immediately redistributes them.

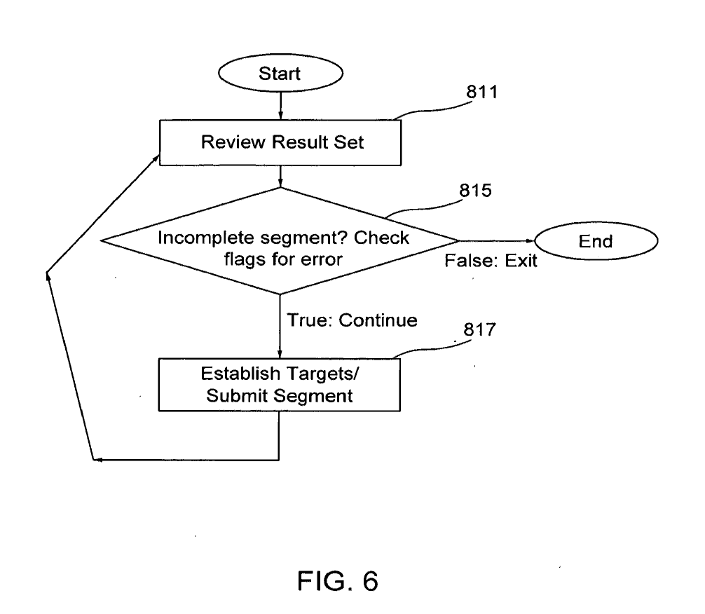

FIG. 6 is a flow chart illustrating a process for redistributing incomplete segments. For instance, a system may review 811 a result set and its relative flags 815 for incomplete data, corrupted data, or missing data. If an incomplete segment is found through checking 815 the error flags (meaning the error flag is true) then the system may redistribute or submit 817 the incomplete task segment for re-processing. If the error flag is false then the system may exit. After resubmission, the system must again wait to compile a processed task.

Alternatively, a system may reorder remaining task segments with any identified incomplete segments and redistributing the remaining task segments according to the reordering. In addition, the system may re-optimize before redistribution to maximize the processing time for the remaining unprocessed data.

A system may, also, not redistribute the task segments. Rather, a system may interpolate the incomplete segments based on relative task segments. Further, the interpolation may be distributed amongst the dynamically available resources based on a model or optimized model.

Further, a system may identify incomplete segments by compiling received task segments rather than checking status flags, such that a system is compiling received task segments simultaneous with dynamically redistributing incomplete segments, as those incomplete segments are identified through the compiling. More specifically, a task segment that cannot be compiled do to segment corruption may be revealed only during compiling.

Alternatively, re-optimization may show that a resource is now unavailable. For instance, if a resource is processing a task segment and through updated the model a system detects that that resource is no longer connected or has failed in some other way, the system may assume that task segment may not be completed and may redistribute or interpolate that segment. Similarly to not receiving a processed segment within a designated processing time, if a component or electronic device is offline for a length of time the system may designate that component or electronic device as unavailable. In other words, the incomplete task segments may be designated incomplete when a task segment has not been received within a processing time that was estimated during optimization, when a device or component goes offline for a designated length of time, or by other similar means. In addition, the dynamically available resources associated with incomplete segments may be excluded from re-optimization, as a system may not want to redistribute task segments to a device that frequently fails to perform without errors.

In addition to the above embodiment, layers of security and compression may be added to some or all transfers. For instance, encryption algorithms may be performed on task segments and completed segments. Further, the selection of groups may be based on secured connections, access levels, or a member's encryptions capabilities. Furthermore, the system may be selective on task segment distribution based on the task demands for security and resources available. These concerns may be addressed in any step in the above embodiment.

Regarding the type of task for shared processing, a system may compute any task. However, the advantages of the above described system are the super-computing and incomplete segment correction abilities. Thus, complex image generation, large scale sampling computation, transcoding, etc. are examples of said task types. For example, a task may be computing a complex algorithm where the segments are individual calculations in the complex algorithm; transcoding a movie where the task segments are individual time segments of the movie; rendering a 3D movie where the task segments are individual pixels segments in a frame of the 3D movie; or annotating an electronic photo album where the segments are individual photos of the electronic photo album.

Further, for example, if an individual Laptop receives a task to transcode a movie, for instance a movie from a camcorder, so that the Laptop may upload the movie to a webpage, such as YouTube.com, the Laptop may take seven hours to transcode one frame of a movie. However, when the above system receives a task request to transcode a movie, the above system may transcode the movie in real time while uploading the movie to YouTube.com, such that for every Laptop within the system a frame may be rendered simultaneously.

Furthermore, if there are two Laptops then the total number of frames is divided by two. Furthermore, for X number of Laptops the total number of frames is divided by X. Thus, if a system has only one Laptop that computes one frame per seven hours then a movie with a million frames would take years to transcode. However, if the system has half a million Laptops with similar capabilities then the movie could be transcoded in roughly fourteen hours plus other processing overhead. In addition, error possibilities may increase with the increase in complexity of a system. Therefore, the above system's task segment redistribution and task interpolation techniques may be implemented. Thus, if connections drop, devices error, or other failures occur the movie may and can still be rendered.

Similarly, a high-resolution image may take 30 minutes for a LAPTOP to render. However, a because the image may be divided and distributed among the available processors such that each separate processor renders a different portion of the photograph (as in a pixel or a set of pixels) the system may reduce the rendering time by a factor of the number of electronic devices connected to the systems.

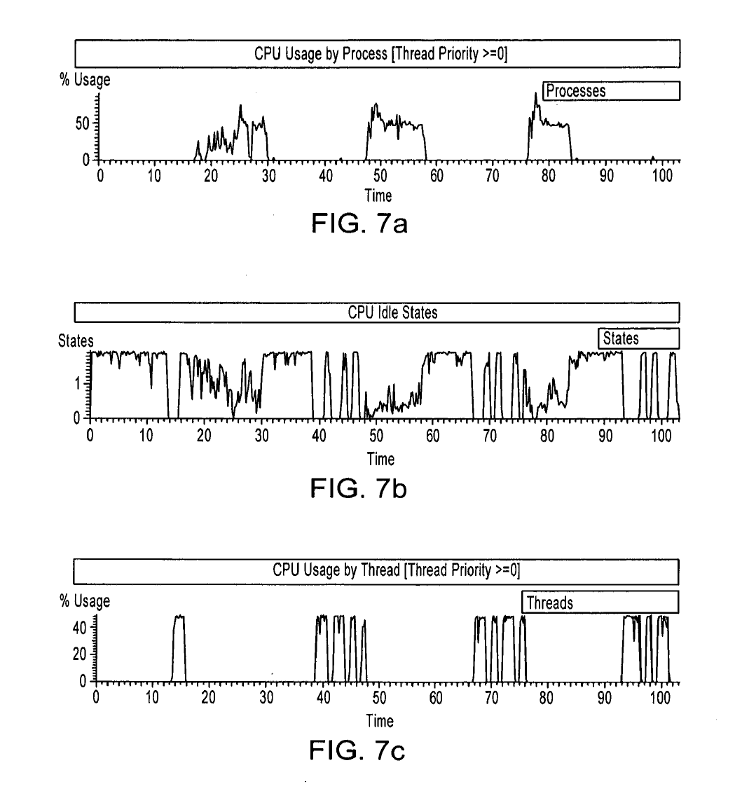

FIGS. 7a-7c are graphs illustrating CPU status over time. Specifically, FIGS. 7a-7b, 8, and 9 are demonstrations of a system transcoding a movie 20 to 40 times faster than if one PC were to transcode the same movie independently.

FIG. 7a is the CPU usage by a PC over time; FIG. 7b is the CPU idle state over time; and FIG. 7C is the CPU usage by the systems over time. When comparing FIGS. 7a to 7b and 7c to 7b it is noted that the idle state is low when the CPU usage is active. Similarly, when comparing FIGS. 7a and 7c the CPU usage by the system is independent of the CPU usage by the PC. Also, when comparing these figures it is noted that after the CPU has been in an idle state for a specific period of time, i.e. 9 increments, the CPU usage by the system goes high; however when the CPU usage by the PC begins the CPU usage by the system immediately stops. These relationships are clearly demonstrated by the four sets of peaks in FIG. 7c and the three sets of peaks in FIG. 7a.

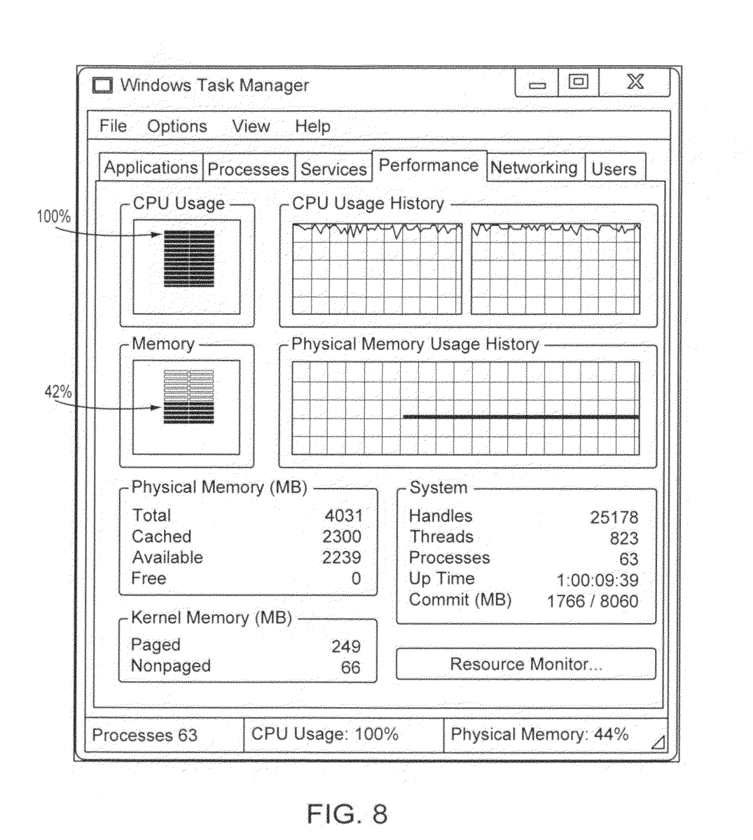

FIG. 8 is a display diagram indicating a device's resource use. In FIG. 8, the PC's CPU usage is at 100%. If this usage is a PC usage then the CPU is not available as a resource for the system because the CPU is at full capacity. However, the physical memory is only at 42%. Thus, the physical memory is 68% idle and is still an available resource for the system. The system may contain a threshold availability for a component where the system may never use a component if its current use is more than a designated amount, such as 50%. If the threshold is met then the system may label that component as an unavailable resource. Thus, if a 50% threshold for the components in FIG. 8 is used then the physical memory is available while the CPU is unavailable.

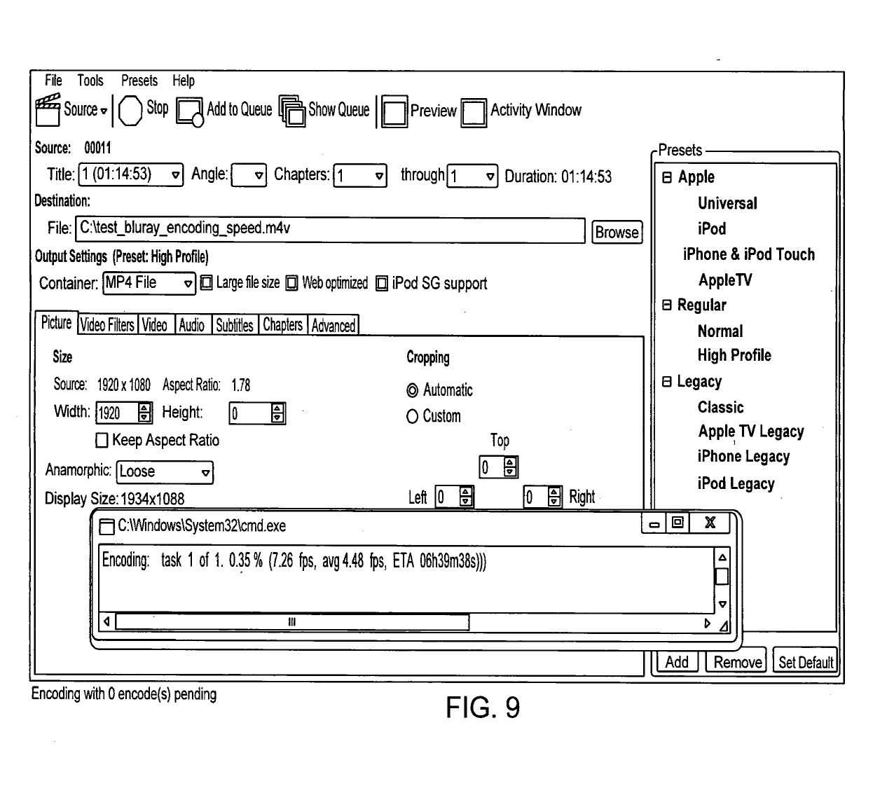

FIG. 9 is a display diagram indicating the time to render a frame. In FIG. 9, the PC in the system is estimating the remaining time to complete a distributed task of transcoding a frame (i.e. ETA 06 h 39 m 38 s). Further, if the frame was divided into segments, such as four quadrants, and this PC was designated to process only one of those segments, i.e. one quadrant, then the amount of time for this PC to finish transcoded would be divided by the number of segments, i.e. 6 h 40 m/4=1 h 40 m.

Alternative embodiments of the system described above may take many forms where the steps are performed simultaneously, are isolated, or are ordered differently. Further, the systems may also be embodied in hardware.

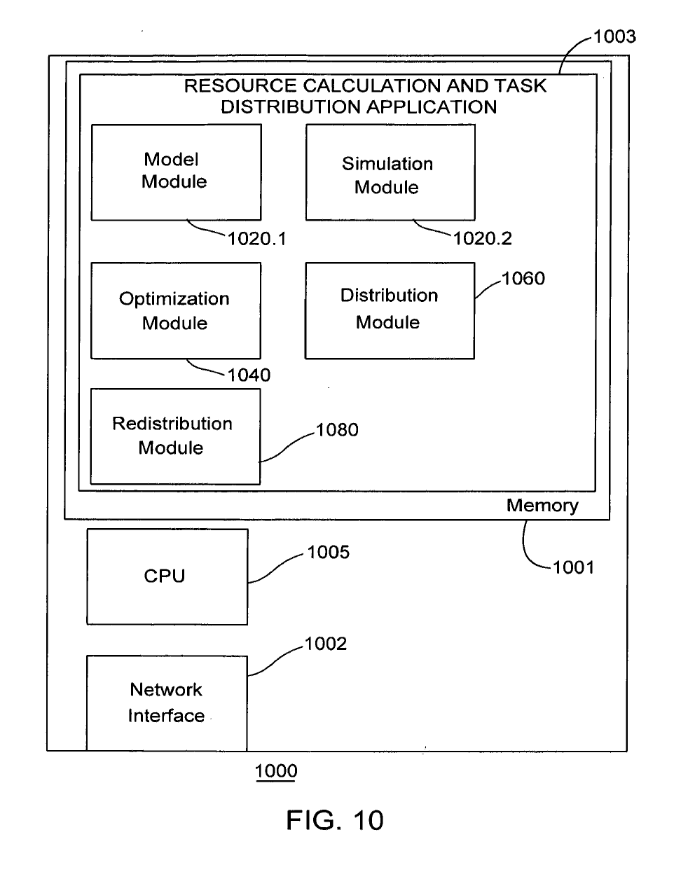

FIG. 10 is a block diagram illustrating a device for calculating and distributing resources. The electronic device 1000 has a memory 1001, a network interface 1002, and a processor 1005. The memory 1001 further has a resource calculation and task distribution application 1003 that contains a model module 1020.1, a simulation module 1020.2, a optimization module 1040, a distribution module 1060, and a redistribution module 1080.

The resource calculation and task distribution application 1003 is preferably constituted of program code executed by the CPU 1005 to provide the operations described herein; however, it may alternatively comprise of hardware, firmware, or combinations of software, hardware, and firmware.

The model module 1020.1 is configured to generate a model based on resources of a plurality of separate electronic devices. The simulation module 1020.2 is configured to simulate an assessment task to determine a computation time for the assessment task according to the model. The optimization module 1040 is configured to update the model to optimize the computation time based on a dynamic availability of the resources and a processing requirement of a live task. The distribution module 1060 is configured to distribute task segments for processing the live task based on the updated model. The redistribution module 1080 is configured to dynamically redistribute incomplete segments for processing the live task by further updating the model based on the dynamic availability of the resources,

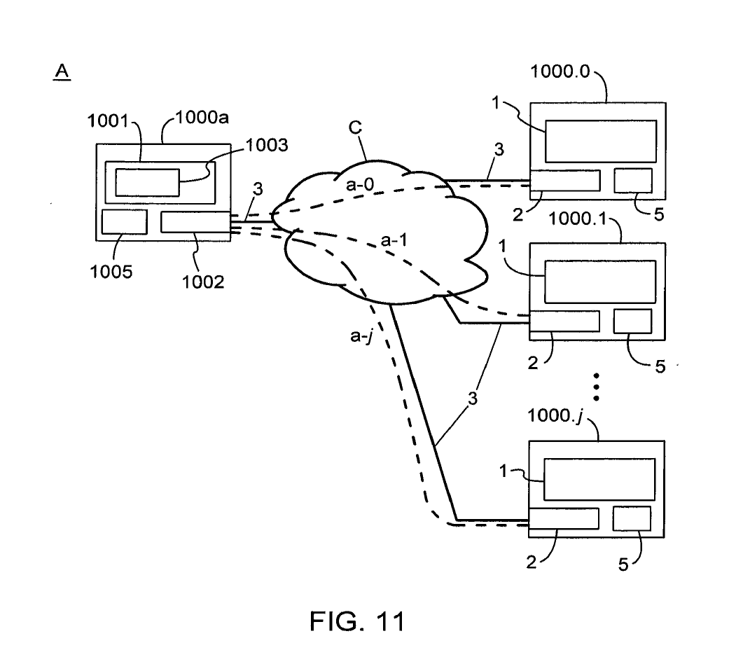

In addition, the system may be a server system that optimizes a client framework. FIG. 11 is a schematic diagram of a system for calculating and distributing resources. In FIG. 11, a system A has an electronic device 1000a that a memory 1001, a network interface 1002, and a processor 1005. The memory may contain any of the combination of modules described above, such as a resource calculation and task distribution application 1003. The electronic device 1000a has a physical connection 3 to a cloud C that permits virtual connections a-0, a-1, and a-j to electronic devices 1000.0, 1000.1, and 1000.j, respectively (where j is an integer representing the total number of electronic devices connected to the system). Each electronic device 1000.0-1000.j has a network interface 2 that has a physical connection 3 to the cloud C and resources 1, network interface 2, and processor 5.

For example, in the server embodiment a laptop, such as a Sony Vaio laptop, may be the server. The Vaio server 1000a may host the Vaio distributed application and manage the clients 1000.0-1000.j by using its resource calculation and task distribution application 1003. Further, the Vaio server 1000a may model the network by using a bandwidth estimator to minimize the time on network, by pinging for response times, and by modeling the available processors in a simulation to collect the statistics. Thus, a model is dynamically updated by a Vaio server 1000a in a Vaio exclusive cloud C.

Once the model is built, a Vaio server 1000a may distribute task segments across the cloud C based on the processing power demanded by a task and the connection speeds, security access, or even licensing and tracking described the model. Also, the clients 1000.0-1000.j may subscribe to multiple systems, networks, or groups. Further, the Vaio server corrects incomplete segments based on the available models and resources.

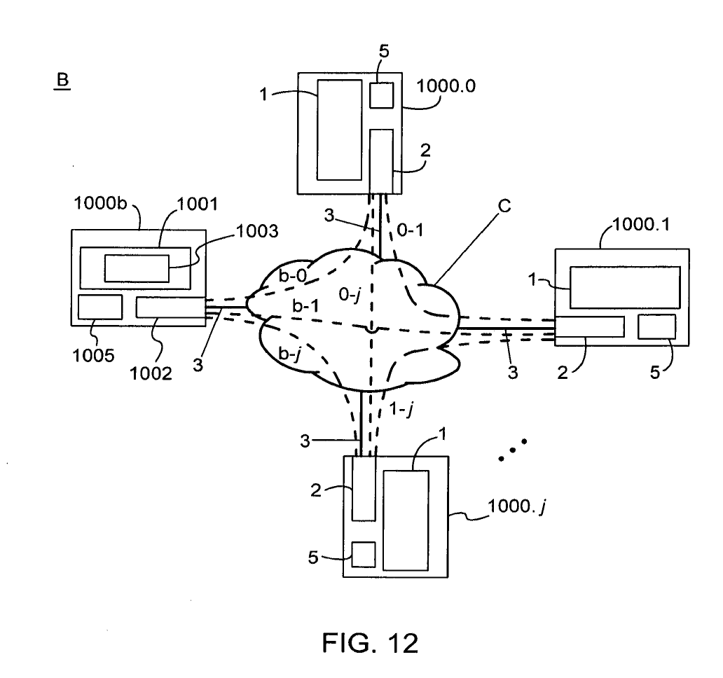

Alternatively, the system may be a self discovering client system. FIG. 12 is a schematic diagram of a self-discoverable electronic device for calculating and distributing resources. In FIG. 12, a system B has an electronic device 1000b that has a memory 1001, a network interface 1002, and a processor 1005. Similarly to the server system, the processor 1001 of the electronic device 1000b may contain any of the combination of modules described above. The electronic device 1000b has physical connection 3 to a cloud C that permits virtual connections b-0, b-1, and b-j to electronic devices 1000.0, 1000.1, and 1000.j, respectively (where j is an integer representing the total number of electronic devices connected to the system). Each electronic device 1000.0-1000.j has a network interface 2 that has a physical connection 3 to the cloud C and resources 1 network interface 2, and processor 5. However, in the self-discovering client system, any electronic device in the system B may create and optimize a distribution model.

For example, a self-discovering application programming interface (API) on a Laptop client 1000b, such as a Sony Vaio laptop, may expose capabilities within the system B. The API would connect to other Sony Vaio clients 1000.1-1000.j in a handshake type communication, i.e. “Hey, are you there?”-“Hey, I am here, idle, and can do work.” Then the Sony Vaio client 1000b would propose a thread for the other Sony Vaio clients 1000.0-1000.j to run on their resources 3. Alternatively, the Sony Vaio client 1000b could request the other Sony Vaio clients 1000.0-1000.j to discover what resources are available on their neighbors, run a thread, and report when they are finished.

Also, in either above system, a CPU Multiplier, which is like a blade computer in an enterprise environment, may be added. CPU multipliers have no hard drive and comprise manly of processing power with a network interface. Thus, any module, for example the monitoring and optimization module, within the system could be supplemented by adding a multiplier.

Similarly, old and new electronic products may be added to the system. For example, an old computer would not necessarily need to be upgraded. It could be added to the system, have access to the aggregate processing power on the network, and be able to distribute, offload, or share a task. And the old computer does not have to be homogeneous with other electronic devices within the system. The old computer could be any different form factor, i.e. Linux, Linux embedded, Windows, etc., or contain any component brand, i.e. AMD or Intel. Further, other electronic devices not typically associated with shared computing, such as TVs, DVRs, etc., may be added. Thus, the present invention allow for a system to connect to devices within a home; describe the cumulative idle time; resource type, i.e. graphics processor, central processor, or any other type of processor know in the art; and distribute task segments to all available devices.

Marketing and selling resource may be another aspect of the system, as current grid computing is meant for enterprises and not meant for general consumers use. Therefore, the above system may allow electronic device owners to permit third-party systems to utilize their idle processing power. The third party may compensate the owners proportionally for the donated processing power. Thus, owners may be able to sell their resources to a third party, donate their resources to a charity, wholesale storage resources to a third party, or all of the above. Also, incentives may be offered, such as movie tickets, points to buy online movies, or tax write-offs for charitable processor donation to encourage electronic device owners to donate their processing power.

Thus embodiments of the present invention produce and provide a system for calculating resources and distributing segments. Although the present invention has been described in considerable detail with reference to certain embodiments, the invention may be variously embodied without departing from the spirit or scope of the invention. Therefore, the following claims should not be limited to the description of the embodiments contained herein in any way.

1. A method for redistributing incomplete segments for processing tasks, comprising:
generating a model based on resources of a plurality of separate electronic devices;
simulating an assessment task to determine a computation time for the assessment task according to the model;
updating the model to optimize the computation time based on a dynamic availability of the resources and a processing requirement of a live task;
distributing task segments for processing the live task based on the updated model; and
dynamically redistributing incomplete segments for processing the live task by further updating the model based on the dynamic availability of the resources.

2. The method of claim 1, wherein resources associated with incomplete segments are excluded from redistribution.

3. The method of claim 1, wherein dynamically redistributing incomplete segments comprises reordering the remaining task segments of the live task and redistributing the remaining task segments according to the reordering.

4. The method of claim 1, wherein dynamically redistributing incomplete segments comprises distributing an interpolation task that interpolates the incomplete segments based on relative task segments.

5. The method of claim 1, further comprising:
compiling task segments simultaneous with dynamically redistributing incomplete segments, and
wherein updating the model identifies incomplete segments.

6. The method of claim 1, further comprising:
compiling task segments simultaneous with dynamically redistributing incomplete segments, and
wherein compiling identifies incomplete segments.

7. The method of claim 6, wherein an incomplete segment is a task segment that cannot be compiled do to segment corruption.

8. The method of claim 1, wherein the incomplete segments are segments that have not been received within a processing time that was estimated during optimization.

9. The method of claim 1, wherein simulating an assessment task maximizes a total processing power of the model.

10. The method of claim 1, wherein resources of a separate electronic device is a set of processors, a set of memories, and a set of communication types.

11. The method of claim 1, wherein the dynamic availability of the resources changes over time respective to a number of separate electronic devices connected and in use and respective to a transfer speed and connection medium of a communication type.

12. The method of claim 1, wherein the live task is transcoding a movie and the task segments are individual time segments of the movie.

13. The method of claim 1, wherein the live task is rendering a 3D movie and the task segments are individual pixels segments in a frame of the 3D movie.

14. The method of claim 1, wherein the live task is a complex algorithm and the task segments are individual calculations in the complex algorithm.

15. The method of claim 1, wherein the live task is annotating an electronic photo album and the task segments are individual photos of the electronic photo album.

16. A method for redistributing incomplete segments for processing tasks, comprising:
generating a model based on resources of a plurality of separate electronic devices;
simulating an assessment task to determine a computation time for the assessment task according to the model;
updating the model to optimize the computation time based on a dynamic availability of the resources and a processing requirement of a live task;
distributing task segments for processing the live task based on the updated model; and
dynamically redistributing incomplete segments for processing the live task by further updating the model based on the dynamic availability of the resources,
wherein each incomplete segment is a task segment that has not been received within an estimated processing time,
wherein the estimated processing time is the result of calculations completed during updating the model.

17. A system for redistributing incomplete segments for processing tasks, comprising:
a first electronic device configured to generate a model based on resources of a plurality of separate electronic devices;
the first electronic device configured to simulate an assessment task to determine a computation time for the assessment task according to the model;
the first electronic device configured to update the model to optimize the computation time based on a dynamic availability of the resources and a processing requirement of a live task;
the first electronic device configured to distribute task segments for processing the live task based on the updated model; and
the first electronic device configured to dynamically redistribute incomplete segments for processing the live task by further updating the model based on the dynamic availability of the resources,

18. A system for redistributing incomplete segments for processing tasks, comprising:
a means to generate a model based on resources of a plurality of separate electronic devices;
a means to simulate an assessment task to determine a computation time for the assessment task according to the model;
a means to update the model to optimize the computation time based on a dynamic availability of the resources and a processing requirement of a live task;
a means to distribute task segments for processing the live task based on the updated model; and
a means to dynamically redistribute incomplete segments for processing the live task by further updating the model based on the dynamic availability of the resources.
